(19) United States
(12) Patent Application Publication
(10) Pub. No.: US 2012/0302439 A1
(43) Pub. Date: Nov. 29, 2012

(54) ENGINE EXHAUST CATALYSTS DOPED WITH BISMUTH OR MANGANESE

(75) Inventors: Xianghong Hao, Kingwood, TX (US); Geoffrey McCool, Hayward, CA (US); Ramesh Sharma, Sunnyvale, CA (US)

(73) Assignee: NANOSTELLAR, INC., Redwood City, CA (US)

(21) Appl. No.: 13/519,705

(22) PCT Filed: Dec. 30, 2010
(86) PCT No.: PCT/US10/62589

§ 371 Date: Jun. 28, 2012

Related U.S. Application Data
(60) Provisional application No. 61/291,786, filed on Dec. 31, 2009.

(51) Int. Cl. B01J 23/656; B01J 23/644; B01J 23/68

(52) U.S. Cl. 502/324; 502/330; 502/339

(57) ABSTRACT

An emission control catalyst is doped with bismuth, manganese, or bismuth and manganese. The doped catalyst may be a palladium-gold catalyst or a platinum-based catalyst, or both. The doped palladium-gold catalyst and the doped platinum-based catalyst may be contained in a single washcoat layer or in different washcoat layers of a multi-brick, multi-zoned, or multi-layered emission control system. In all embodiments, zeolite may be added as a hydrocarbon absorbing component.

### BACKGROUND OF THE INVENTION

1. Field of the Invention

Embodiments of the present invention are directed to engine exhaust catalysts and more particularly to engine exhaust catalysts doped with bismuth or manganese.

2. Description of the Related Art

Supported catalysts are quite useful in removing pollutants from vehicle exhausts. Vehicle exhausts contain harmful pollutants, such as carbon monoxide (CO), unburned hydrocarbons (HC), and nitrogen oxides (NOx), that contribute to the “smog-effect” that have plagued major metropolitan areas across the globe. Catalytic converters containing supported catalysts and particulate filters have been used to remove such harmful pollutants from the vehicle exhaust. While pollution from vehicle exhaust has decreased over the years from the use of catalytic converters and particulate filters, research into improved supported catalysts has been continuing as requirements for vehicle emission control have become more stringent and as vehicle manufacturers seek to use less amounts of precious metal in the supported catalysts to reduce the total cost of emission control.

The prior art teaches the use of supported catalysts containing palladium and gold as good partial oxidation catalysts. As such, they have been used extensively in the production of vinyl acetate in the vapor phase by reaction of ethylene, acetic acid and oxygen. See, e.g., U.S. Pat. No. 6,022,823. As for vehicle emission control applications, U.S. Pat. No. 6,763,309 speculates that palladium-gold might be a good bimetallic candidate for increasing the rate of NO decomposition. The disclosure, however, is based on a mathematical model and is not supported by experimental data. There is also no teaching in this patent that a palladium-gold system will be effective in treating vehicle emissions that include CO and HC.

### SUMMARY OF THE INVENTION

Embodiments of the present invention provide an emission control catalyst doped with bismuth, manganese, or bismuth and manganese. The doped catalyst may be a palladium-gold catalyst or a platinum-based catalyst, or both. The doped palladium-gold catalyst and the doped platinum-based catalyst may be contained in a single washcoat layer or in different washcoat layers of a multi-brick, multi-zoned, or multi-layered emission control system. In all embodiments, zeolite may be added as a hydrocarbon absorbing component.

In a first embodiment, an engine exhaust catalyst includes a palladium-gold catalyst doped with bismuth, manganese, or combinations thereof. The engine catalyst may optionally include a platinum-based catalyst. The platinum-based catalyst is optionally doped with bismuth, manganese, or combinations thereof. For example, the platinum-based catalyst is a platinum-palladium catalyst.

In a second embodiment, an engine exhaust catalyst includes multiple washcoat zones or layers and a palladium-based catalyst doped with bismuth or manganese, or bismuth and manganese, is included in at least one of the washcoat zones or layers. In one example, the palladium-based catalyst is palladium gold. The engine exhaust catalyst may optionally include a platinum-based catalyst in the same or different washcoat zones or layers. The platinum-based catalyst may be doped with bismuth or manganese, or bismuth and manganese. In one example, the platinum-based catalyst comprises a platinum-palladium catalyst.

In a third embodiment, an engine exhaust catalyst includes a platinum-palladium catalyst doped with bismuth, manganese, or combinations thereof. The engine catalyst may optionally include a palladium-based catalyst. The palladium-based catalyst is optionally doped with bismuth, manganese, or combinations thereof. For example, the palladium-based catalyst is a palladium-gold catalyst.

In a fourth embodiment, an engine exhaust catalyst includes multiple washcoat zones or layers and a platinum-based catalyst doped with bismuth or manganese, or bismuth and manganese, is included in at least one of the washcoat zones or layers. In one example, the platinum-based catalyst is platinum-palladium. The engine exhaust catalyst may optionally include a palladium-based catalyst in the same or different washcoat zones or layers. The palladium-based catalyst may be doped with bismuth or manganese, or bismuth and manganese. In one example, the palladium-based catalyst comprises a palladium-gold catalyst.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D are schematic representations of different engine exhaust systems in which embodiments of the present invention may be used.

FIG. 2 is an illustration of a catalytic converter with a cut-away section that shows a substrate onto which emission control catalysts according to embodiments of the present invention are coated.

FIGS. 3A-3D illustrate different configurations of a substrate for an emission control catalyst.

FIG. 4 shows the light-off data comparison for PtPdBi and PtPdMn for CO oxidation.

FIG. 5 shows the light-off data comparison for PtPdBi and PtPdMn for C₃H₆ conversion.

FIG. 6A shows the light-off data comparison for PdAuBi and PdAuMn for CO oxidation in a first run. FIG. 6B shows the light-off data comparison for PdAuBi and PdAuMn for CO oxidation a the second run.

FIG. 7A shows the light-off data comparison for PdAuMn for NO conversion in a first run. FIG. 7B shows the light-off data comparison for PdAuMn for NO conversion in a second run.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in the claims. Likewise, reference to “the invention” shall not be construed as a generalization of any inventive subject matter disclosed herein and shall not be considered to be an element or limitation of the appended claims except where explicitly recited in the claims.

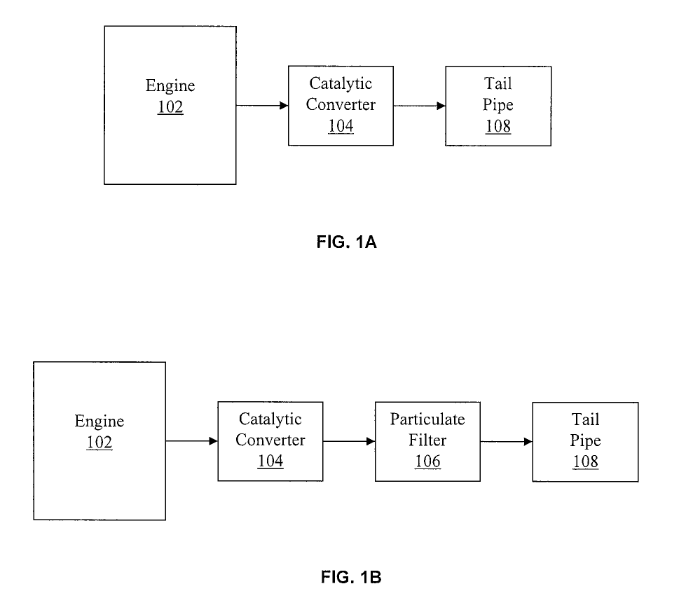

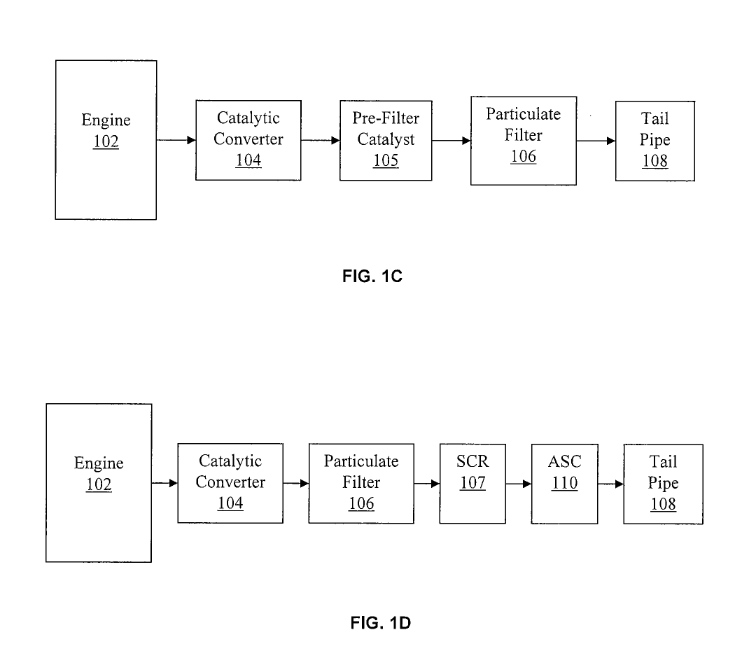

FIGS. 1A-1D are schematic representations of different engine exhaust systems in which embodiments of the present invention may be used. The combustion process that occurs in an engine 102 produces harmful pollutants, such as CO, various hydrocarbons, particulate matter, and nitrogen oxides (NOₓ), in an exhaust stream that is discharged through a tail pipe 108 of the exhaust system.

In the exhaust system of FIG. 1A, the exhaust stream from an engine 102 passes through a catalytic converter 104, before it is discharged into the atmosphere (environment) through a tail pipe 108. The catalytic converter 104 contains supported catalysts coated on a monolithic substrate that treat the exhaust stream from the engine 102. The exhaust stream is treated by way of various catalytic reactions that occur within the catalytic converter 104. These reactions include the oxidation of CO to form CO₂, burning of hydrocarbons, and the conversion of NO to NO₂.

In the exhaust system of FIG. 1 B, the exhaust stream from the engine 102 passes through a catalytic converter 104 and a particulate filter 106, before it is discharged into the atmosphere through a tail pipe 108. The catalytic converter 104 operates in the same manner as in the exhaust system of FIG. 1A. The particulate filter 106 traps particulate matter that is in the exhaust stream, e.g., soot, liquid hydrocarbons, generally particulates in liquid form. In an optional configuration, the particulate filter 106 includes a supported catalyst coated thereon for the oxidation of NO and/or to aid in combustion of particulate matter.

In the exhaust system of FIG. 1C, the exhaust stream from the engine 102 passes through a catalytic converter 104, a pre-filter catalyst 105 and a particulate filter 106, before it is discharged into the atmosphere through a tail pipe 108. The catalytic converter 104 operates in the same manner as in the exhaust system of FIG. 1A. The pre-filter catalyst 105 includes a monolithic substrate and supported catalysts coated on the monolithic substrate for the oxidation of NO. The particulate filter 106 traps particulate matter that is in the exhaust stream, e.g., soot, liquid hydrocarbons, generally particulates in liquid form.

In the exhaust system of FIG. 1D, the exhaust stream passes from the engine 102 through a catalytic converter 104, a particulate filter 106, a selective catalytic reduction (SCR) unit 107 and an ammonia slip catalyst 110, before it is discharged into the atmosphere through a tail pipe 108. The catalytic converter 104 operates in the same manner as in the exhaust system of FIG. 1A. The particulate filter 106 traps particulate matter that is in the exhaust stream, e.g., soot, liquid hydrocarbons, generally particulates in liquid form. In an optional configuration, the particulate filter 106 includes a supported catalyst coated thereon for the oxidation of NO and/or to aid in combustion of particulate matter. The SCR unit 107 is provided to reduce the NOₓ species to N2. The SCR unit 107 may be ammonia/urea based or hydrocarbon based. The ammonia slip catalyst 110 is provided to reduce the amount of ammonia emissions through the tail pipe 108. An alternative configuration places the SCR unit 107 in front of the particulate filter 106.

Alternative configurations of the exhaust system includes the provision of SCR unit 107 and the ammonia slip catalyst 110 in the exhaust system of FIG. 1A or 1C, and the provision of just the SCR unit 107, without the ammonia slip catalyst 110, in the exhaust system of FIGS. 1A, 1B or 1C.

As particulates get trapped in the particulate filter within the exhaust system of FIG. 1B, 1C or 1D, it becomes less effective and regeneration of the particulate filter becomes necessary. The regeneration of the particulate filter can be either passive or active. Passive regeneration occurs automatically in the presence of NO₂. Thus, as the exhaust stream containing NO₂ passes through the particulate filter, passive regeneration occurs. During regeneration, the particulates get oxidized and NO₂ gets converted back to NO. In general, higher amounts of NO₂ improve the regeneration performance, and thus this process is commonly referred to as NO₂ assisted oxidation. However, too much NO₂ is not desirable because excess NO₂ is released into the atmosphere and NO₂ is considered to be a more harmful pollutant than NO. The NO₂ used for regeneration can be formed in the engine during combustion, from NO oxidation in the catalytic converter 104, from NO oxidation in the pre-filter catalyst 105, and/or from NO oxidation in a catalyzed version of the particulate filter 106.

Active regeneration is carried out by heating up the particulate filter 106 and oxidizing the particulates. At higher temperatures, NO₂ assistance of the particulate oxidation becomes less important. The heating of the particulate filter 106 may be carried out in various ways known in the art. One way is to employ a fuel burner which heats the particulate filter 106 to particulate combustion temperatures. Another way is to increase the temperature of the exhaust stream by modifying the engine output when the particulate filter load reaches a pre-determined level.

The present invention provides catalysts that are to be used in the catalytic converter 104 shown in FIGS. 1A-1D, or generally as catalysts in any vehicle emission control system, including as a diesel oxidation catalyst, a diesel filter catalyst, an ammonia-slip catalyst, an SCR catalyst, or as a component of a three-way catalyst. The present invention further provides a vehicle emission control system, such as the ones shown in FIGS. 1A-1D, comprising an emission control catalyst comprising a monolith and a supported catalyst coated on the monolith.

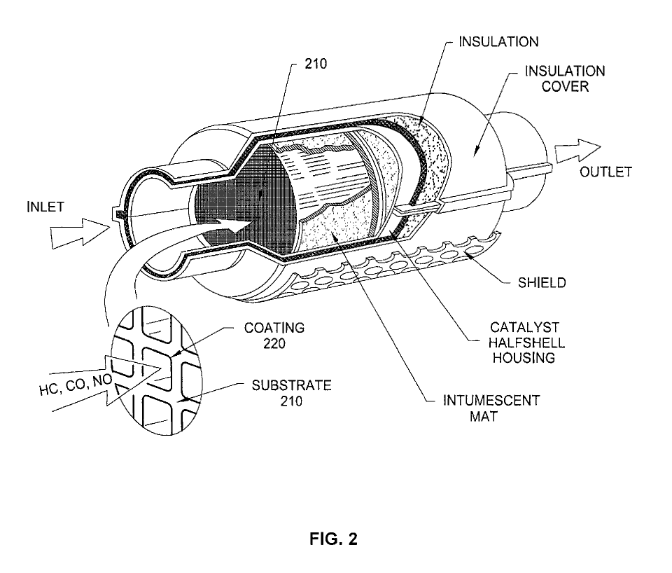

FIG. 2 is an illustration of a catalytic converter with a cut-away section that shows a substrate 210 onto which supported metal catalysts are coated. The exploded view of the substrate 210 shows that the substrate 210 has a honeycomb structure comprising a plurality of channels into which washcoats containing supported metal catalysts are flowed in slurry form so as to form coating 220 on the substrate 210.

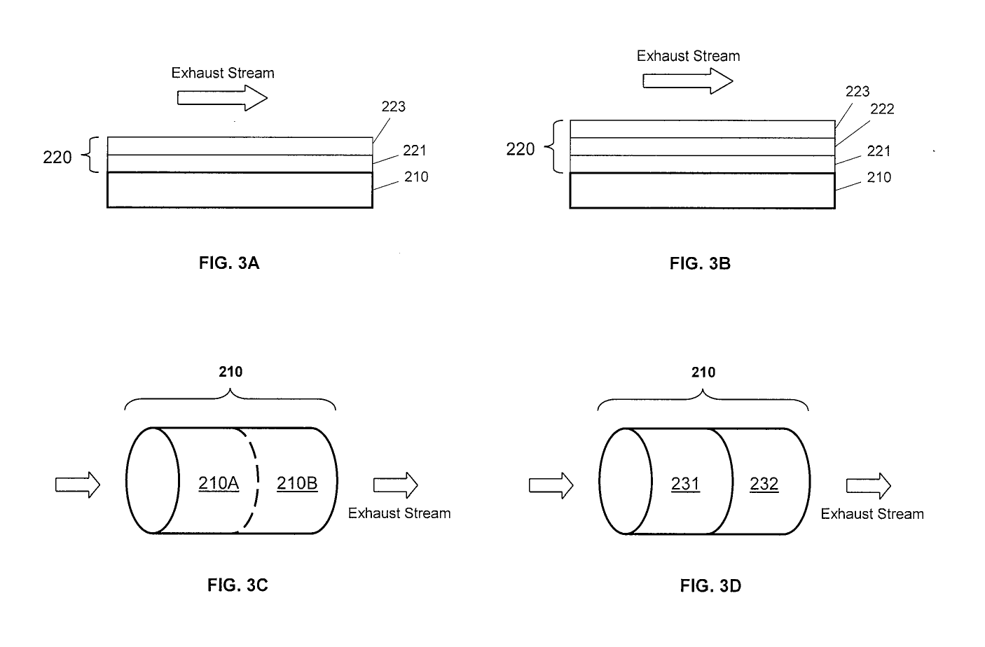

FIGS. 3A-3D illustrate different embodiments of the present invention. In the embodiment of FIG. 3A, coating 220 comprises two washcoat layers 221, 223 on top of substrate 210. Washcoat layer 221 is the bottom layer that is disposed directly on top of the substrate 210. Washcoat layer 223 is the top layer that is in direct contact with the exhaust stream. Based on their positions relative to the exhaust stream, washcoat layer 223 encounters the exhaust stream before washcoat layer 221.

In the embodiment of FIG. 3B, coating 220 comprises three washcoat layers 221, 222, 223 on top of substrate 210. Washcoat layer 221 is the bottom layer that is disposed directly on top of the substrate 210. Washcoat layer 223 is the top layer that is in direct contact with the exhaust stream. Washcoat layer 222 is the middle layer that is disposed in between washcoat layers 221, 223. The middle layer is also referred to as a buffer layer. Based on their positions relative to the exhaust stream, washcoat layer 223 encounters the exhaust stream before washcoat layers 221, 222, and washcoat layer 222 encounters the exhaust stream before washcoat layer 221.

In the embodiment of FIG. 3C, the substrate 210 is a single monolith that has two coating zones 210A, 210B. A first washcoat is coated onto a first zone 210A and a second washcoat is coated onto a second zone 210B. In the embodiment of FIG. 3D, the substrate 210 includes first and second monoliths 231, 232, which are physically separate monoliths. A first washcoat is coated onto the first monolith 231 and a second washcoat is coated onto the second monolith 232.

All of the embodiments of the present invention include an engine exhaust catalyst doped with bismuth (Bi) or manganese (Mn), or both. The engine exhaust catalyst includes a supported platinum-palladium catalyst or a supported palladium-gold catalyst, or both. Bi doping shows enhancement on CO conversions for both Pt-Pd catalyst and Pd-Au catalyst. Mn doping shows enhancement on both CO and NO conversions for both Pt-Pd catalyst and Pd-Au catalyst.

### Example 1: PtPdBi (3% Pt, 1.5% Pd, 2% Bi) Synthesis Procedure

Weigh out 1.96 g of PtPd (3% Pt, 1.5% Pd) supported on Al₂O₃ pre-synthesized powder.

Mix 1 mL of 40 mg/mL bismuth acetate, 3 mL of H₂O and 1 mL of acetic acid.

Drop wise add solution made in step 2 to the 1.96 g of powder prepared in step 1; mix to homogenous slurry. Keep at room temperature for 1 hr.

Dry at 120° C. for 4 hrs.

### Example 2: PtPdMn (3% Pt, 1.5% Pd, 2% Mn) Synthesis Procedure

Weigh out 1.96 g of PtPd (3% Pt, 1.5% Pd) supported on Al₂O₃ pre-synthesized powder.

Mix 1 mL of 40 mg/mL manganese acetate, 3 mL of H₂O and 1 mL of acetic acid.

Drop wise add solution made in step 2 to the 1.96 g of powder prepared in step 1 while stirring. Keep at room temperature for 1 hr.

Dry at 120° C. for 4 hrs.

### Example 3: PdAuBi (1.67% Pd, 2% Au, 2% Bi) Synthesis Procedure

Weigh out 1.96 g of PdAu (1.67% Pt, 2% Pd) supported on Al₂O₃ pre-synthesized powder.

Mix 1 mL of 40 mg/mL bismuth acetate, 3 mL of H₂O and 1 mL of acetic acid.

Drop wise add solution made in step 2 to the 1.96 g of powder prepared in step 1; mix to homogenous slurry. Keep at room temperature for 1 hr.

Dry at 120° C. for 4 hrs.

### Example 4: PdAuMn (1.67% Pd, 2% Au, 2% Mn) Synthesis Procedure

Weigh out 1.96 g of PdAu (1.67% Pt, 2% Pd) supported on Al₂O₃ pre-synthesized powder.

Mix 1 mL of 40 mg/mL manganese acetate, 3 mL of H₂O and 1 mL of acetic acid.

Drop wise add solution made in step 2 to the 1.96 g of powder prepared in step 1 while stirring. Keep at room temperature for 1 hr.

Dry at 120° C. for 4 hrs.

### Light-Off Test Conditions

All the tests are in the condition of 1000 ppm CO; 105 ppm C₃H₈, 245 ppm C₃H₆, 450 ppm NOₓ. During the run, gas mixtures were flowed at 35° C. for 15 min, 35° C. to 300° C. (10° C./min) in 1st run, cool down in full gas mixture to 50° C., then ramp to 300° C. (10° C./min) in 2^{nd} run. Samples used were 10 mg samples diluted with 90 mg α-alumina.

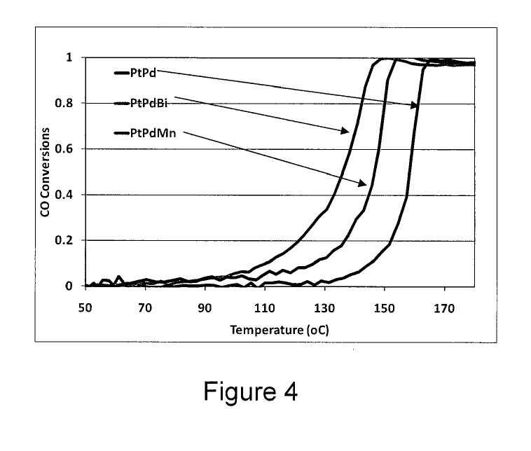

FIG. 4 shows the light-off data comparison for PtPdBi and PtPdMn for CO oxidation. All the catalysts were calcined at 500° C. for 2 hrs. before testing.

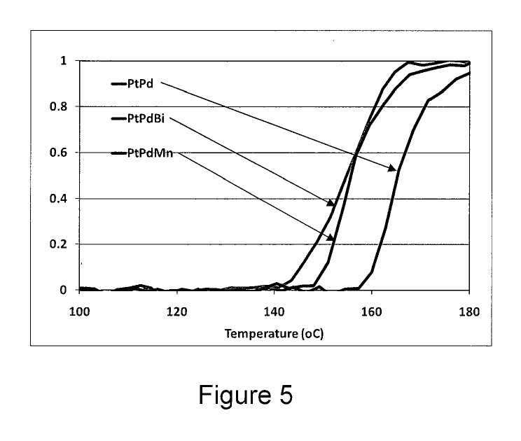

FIG. 5 shows the light-off data comparison for PtPdBi and PtPdMn for C₃H₆ conversion. All the catalysts were calcined at 500° C. for 2 hrs. before testing.

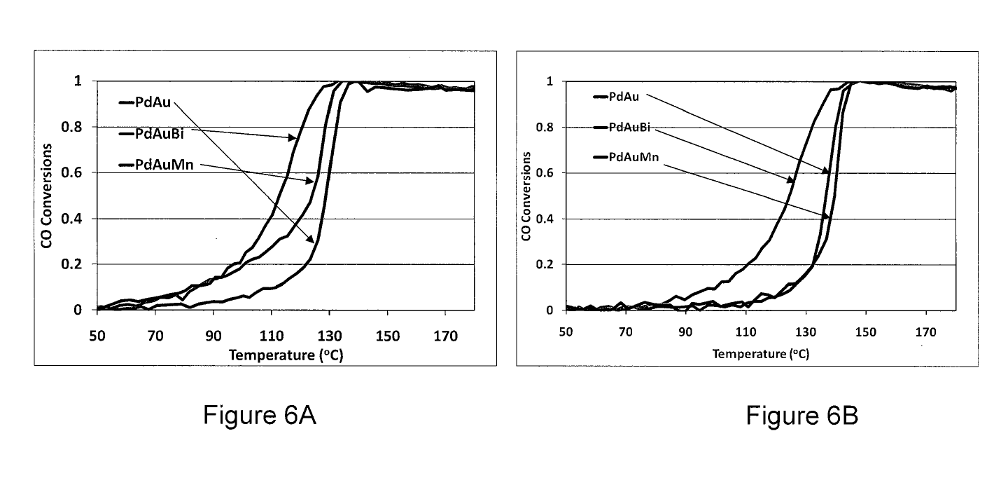

FIG. 6A shows the light-off data comparison for PdAuBi and PdAuMn for CO oxidation in the first run. FIG. 6B shows the light-off data comparison for PdAuBi and PdAuMn for CO oxidation in the second run. All the catalysts were calcined at 500° C. for 2 hrs. before testing.

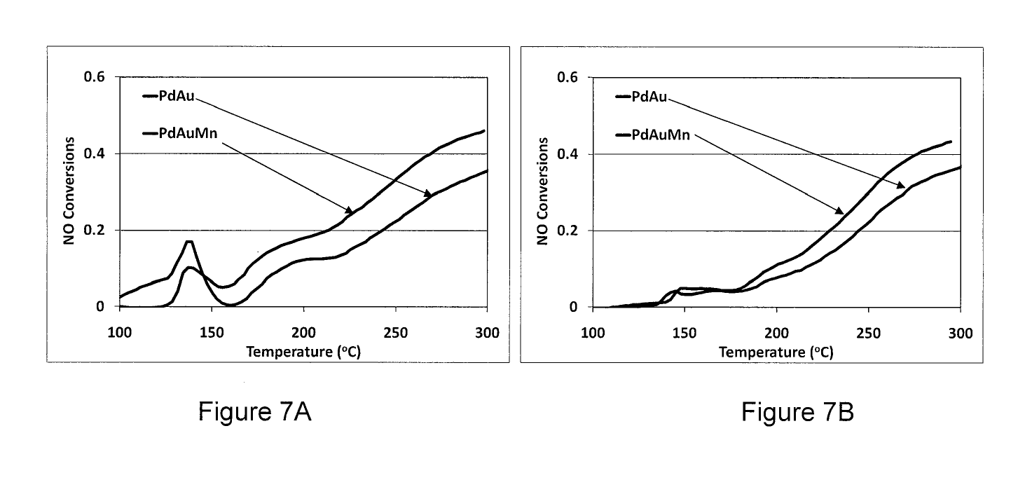

FIG. 7A shows the light-off data comparison for PdAuMn for NO conversion in the first run. FIG. 7B shows the light-off data comparison for PdAuMn for NO conversion in the second run. All the catalysts were calcined at 500° C. for 2 hrs. before testing.

A first embodiment of the present invention is an engine exhaust catalyst having a single washcoat layer design containing either palladium-gold or platinum-palladium, or both, doped with bismuth, manganese, or both. The doped catalysts are better than either undoped versions at least in CO light off. In the monolith reactor, laminar flow in the channel helps utilize exotherm generated by early CO oxidation for HC oxidation. If palladium gold is included, the weight ratio of the palladium to gold may be from 3:1 to 1:3, preferably, from 2:1 to 1:2. If platinum palladium is included, the weight ratio of the platinum to palladium may be from 4:1 to 1:4, preferably, from 3:1 to 1:2. The catalyst may be doped with bismuth in an amount from about 0.2% to 5% by weight of the catalyst, preferably, from 1% to 3% by weight of the catalyst. Alternatively, the catalyst may be doped with manganese in an amount from about 0.2% to 5% by weight of the catalyst, preferably, from 1% to 3% by weight of the catalyst. Bismuth and manganese both may be included in an amount from about 0.2% to 10% by weight of the catalyst, preferably, from 2% to 6% by weight of the catalyst.

A second embodiment of the present invention is an engine exhaust catalyst having 2-layer design or a 3-layer design, where each of the layers may include platinum-palladium, palladium-gold, or both. For example, in a two layer design, one of the layers contains platinum-palladium and the other layer contains palladium-gold. For the palladium gold catalyst, the weight ratio of the palladium to gold may be from 3:1 to 1:3, preferably, from 2:1 to 1:2. For the platinum palladium catalyst, the weight ratio of the platinum to palladium may be from 4:1 to 1:4, preferably, from 3:1 to 1:2. Bismuth, manganese, or both can be applied in any of the layers and to platinum-palladium, palladium-gold, or both. The catalyst may be doped with bismuth in an amount from about 0.2% to 5% by weight of the catalyst, preferably, from 1% to 3% by weight of the catalyst. Alternatively, the catalyst may be doped with Manganese in an amount from about 0.2% to 5% by weight of the catalyst, preferably, from 1% to 3% by weight of the catalyst. Bismuth and manganese both may be included in an amount from about 0.2% to 10% by weight of the catalyst, preferably, from 2% to 6% by weight of the catalyst. In another embodiment, one of the layers may include platinum catalyst or palladium catalyst.

Embodiments of the present invention include providing the doped catalyst in one or more zones of the substrate. Therefore, the description herein with respect to washcoat layers applies equally to providing metal particles in zones containing platinum-palladium, palladium-gold, or both, doped with bismuth, manganese, or both. In one embodiment, instead of the coating the monolith with the supported catalysts in washcoat layers, the catalysts may be coated on the monolith using two or more coating zones, as shown in FIGS. 3C and 3D. For example, instead of three layers, the monolith may be coated with three zones of catalysts. In yet another embodiment, the monolith may be coated with a combination of zones and layers of different catalyst formulations. If desired, the zones and/or layers may overlap to provide even more flexibility for the catalyst design.

In the embodiments described herein, the engine exhaust catalyst may optionally include one or more zeolites such as ZSM5 zeolite, HY zeolite, beta zeolite, mordenite, ferrierite, and combinations thereof. In some embodiments, ceria (CeO₂) and alumina (Al₂O₃) may be added as components. The zeolites and other components may be included in one or more of the washcoat layers.

In summary, Bi and Mn doped PtPd and PdAu are better than non-doped in CO oxidation. Bi doping may be less efficient for hydrocarbon oxidation, but reaction heat generated by early CO light off should be helpful for hydrocarbon light off in monolith reactor. Mn doping enhances NO oxidation activity as well. It is promising if making NO₂ is desired. Incorporating Bi and Mn in engine exhaust catalysts containing palladium-gold should result in cost reduction.

In one embodiment, an engine exhaust catalyst includes a palladium-gold catalyst doped with bismuth, manganese, or combinations thereof. In another embodiment, the engine catalyst may also include a platinum-based catalyst. The platinum-based catalyst is optionally doped with bismuth, manganese, or combinations thereof. For example, the platinum-based catalyst is a platinum-palladium catalyst.

In another embodiment, an engine exhaust catalyst includes multiple washcoat zones or layers and a palladium-based catalyst doped with bismuth or manganese, or bismuth and manganese, is included in one of the washcoat zones or layers. In one embodiment, the palladium-based catalyst is palladium gold. The engine exhaust catalyst may optionally include a platinum-based catalyst in another one of the washcoat zones or layers. The platinum-based catalyst may be doped with bismuth or manganese, or bismuth and manganese. In one example, the platinum-based catalyst comprises a platinum-palladium catalyst.

While particular embodiments according to the invention have been illustrated and described above, those skilled in the art understand that the invention can take a variety of forms and embodiments within the scope of the appended claims.

What is claimed is:

1. An engine exhaust catalyst comprising a palladium-gold catalyst doped with bismuth or manganese, or bismuth and manganese.

2. The engine exhaust catalyst according to claim 1, further comprising a platinum-based catalyst.

3. The engine exhaust catalyst according to claim 2, wherein the platinum-based catalyst is doped with bismuth or manganese, or bismuth and manganese.

4. The engine exhaust catalyst according to claim 3, wherein the platinum-based catalyst comprises a platinum-palladium catalyst.

5. An engine exhaust catalyst comprising multiple washcoat zones or layers and a palladium-gold catalyst doped with bismuth or manganese, or bismuth and manganese, is included in one of the washcoat zones or layers.

6. The engine exhaust catalyst according to claim 5, wherein a platinum-based catalyst is included in another one of the washcoat zones or layers.

7. The engine exhaust catalyst according to claim 6, wherein the platinum-based catalyst is doped with bismuth or manganese, or bismuth and manganese.

8. The engine exhaust catalyst according to claim 7, wherein the platinum-based catalyst comprises a platinum-palladium catalyst.

9. An engine exhaust catalyst comprising a platinum-based catalyst doped with bismuth or manganese, or bismuth and manganese.

10. The engine exhaust catalyst according to claim 9, further comprising a palladium-based catalyst.

11. The engine exhaust catalyst according to claim 10, wherein the palladium-based catalyst is doped with bismuth or manganese, or bismuth and manganese.

12. The engine exhaust catalyst according to claim 11, wherein the platinum-based catalyst comprises a platinum-palladium catalyst.

13. An engine exhaust catalyst comprising multiple washcoat zones or layers and a platinum-based catalyst doped with bismuth or manganese, or bismuth and manganese, is included in one of the washcoat zones or layers.

14. The engine exhaust catalyst according to claim 13, wherein a palladium-based catalyst is included in another one of the washcoat zones or layers.

15. The engine exhaust catalyst according to claim 14, wherein the palladium-based catalyst is doped with bismuth or manganese, or bismuth and manganese.
